(19) United States
(12) Patent Application Publication
(10) Pub. No.: US 2002/0011081 A1
(43) Pub. Date: Jan. 31, 2002

(54) Method of manufacturing a cathode ray tube

(76) Inventors: Mohammed Khalil, Eindhoven (NL); Hermanus Nicolaas Tuin, Eindhoven (NL); Li Zhang, Eindhoven (NL)

Correspondence Address: Jack E. Haken, U.S Philips Corporation, 580 White Plains Road, Tarrytown, NY, 10591, US

(21) Appl. No.: 09/840,210

(22) Filed: Apr. 23, 2001

(30) Foreign Application Priority Data
Apr. 26, 2000 (EP) 00201498.3

(51) Int. Cl. C03B 21/00; C03B 27/00; C03B 33/00

(52) U.S. Cl. 65/102; 65/376

(57) ABSTRACT

To increase the strength of the glass panel, for example of a CRT, the surface temperature of the glass panel at the inner surface of the corners is reduced, during press-forming, to a value below the surface temperature at the inner surface at the centre, the difference being preferably 50° C.-150° C. The forced cooling at the corners compensates for the larger reheating effect in the corners than at the centre that occurs after formation. As a consequence of this compensating effect, a more homogeneous distribution of surface stresses is obtained, increasing the strength of the glass panel.

The invention relates to a method of manufacturing a display tube comprising the step of press-forming a glass display panel.

In the known methods, a glass panel is press-formed, which usually takes place at very high temperatures (1000° C.-1100° C.).

In this manner, a glass face panel can be formed. Cathode ray tubes, for example, comprise a glass display panel which is press-formed.

Cathode ray tubes (CRTs) are becoming increasingly larger, thus increasing the weight of the CRTs. Furthermore, the front surface of the glass panel is becoming increasingly flatter. However, increasing the flatness of the front surface of the face panel generally also increases the weight of the glass panel because the thickness of the glass panel has to be increased to ensure safety against implosion or explosion of the CRT.

Therefore, there is a great need to increase the strength of the CRT, in particular of the glass panel. An increase of the strength of the glass panel may improve the yield.

It is an object of the present invention to provide a method which allows an increase of the yield of the method and/or a reduction of the weight of the glass panel.

To this end, the method in accordance with the invention is characterized in that, during at least a part of the step of press-forming the glass panel, the surface temperature of the inner corners of the panel is kept at a value below the surface temperature of the centre of the glass panel.

The invention is based on the recognition that, during and after glass panel pressing, inhomogeneities in the stress level in the panel may occur. In particular, the stress at the inner corners of CRT panels (i.e. the areas where the face and sidewalls of the panels join) may become less compressive than on the remaining parts of the surface of the panel. This strongly reduces the efficiency of the panel processing during CRT manufacture, thereby reducing the yield. Moreover, this may seriously affect the safety of the tubes. This is particularly important for panels with an (almost) flat inner and/or outer surface such as Real Flat panels, because the amount of stress required for processing and safety in these panels is higher than for less flat panels. Since stress inhomogeneities are often the result of temperature differences, it seems counterproductive to introduce temperature inhomogeneities during press-forming. The invention is, however, based on the recognition that one important reason for the occurrence of severe stress inhomogeneities is the fact that the hot glass is press-formed in a relatively cooler press. The outer surface temperature is thus lower than the temperature of the inner parts of the glass (which have been less cooled). After pressing, the inner parts of the glass are still at a higher temperature than the surface temperature. After pressing, the surface temperature of the glass increases again due to heat transfer from the (still hot) bulk of the glass panel to the surface parts. This reheating process does not have an equal effect in all parts of the panel. In the corners, the mass of the glass is relatively large, whereas the contact surface with the press is relatively small. A relatively large reheating effect occurs at the corners. In the centre, the mass of the glass is relatively small due to the relatively small thickness of the glass panel, whereas the surface is relatively large. Thus, a relatively small reheating effect occurs. Furthermore, the time during pressing between the ‘cold’ plunger and the glass is relatively shorter in the corners than at the centre. Thus the surface temperature itself may be higher at the corners than at the centre. The reheating effect induces large temperature difference in the glass panel and in particular large temperature differences near the corners. As a result, larger stress release (reducing the stress) occurs at the corners, which are the parts of the panel in which the tensile stresses tend to concentrate due to geometrical reasons. In the method in accordance with the invention, the corner parts of the panel are at a lower temperature than the centre during press-forming. The reheating effect will occur. This effect will increase the temperature more in the corners than in the centre, but since the starting temperature (i.e. the temperature during press-forming) is lower in the corners than in the centre, the temperature differences will decrease, leading to a decrease in stress release due to reheating, in particular near and around the corners, and an increase of the surface compression and thereby the safety of the panel. This effect may for instance be used in practice to manufacture panels with a lower weight, or panels with a flatter front surface, or to reduce the fall-out (=percentage of panels that does not pass safety tests) or any combination of these effects.

Preferably around the inner periphery of the glass panel, the surface temperature is kept below the surface temperature of the centre of the glass panel. The above-described reheating effect is greatest in the corners. It occurs, however, also at other positions around the periphery of the glass panel. For some glass panels, the thickness of the panel is even thicker at the ends of the short or long axis of the glass panel (N-S-E or W ends). In such circumstances, a relatively large reheating effect could occur at these points, and keeping the surface temperature below the surface temperature at the centre will be beneficial.

Preferably, the corners or the periphery are kept at a surface temperature which, during at least a part of the step of press-forming, is 50 to 150° C. below the temperature of the centre of the display panel. The above-described reheating effect induces surface temperature differences of the same or similar magnitude, depending on the panel design (flatness, thickness) and the speed of pressing (generally 1-3 panels per minute).

In preferred embodiments, the surface temperatures after press-forming does not rise above the strain point of the glass and preferably stays at least 30 degrees Kelvin below the strain point. When, due to the reheating effect, the surface temperature rises above the strain point, the strain is most effectively released and large stress inhomogeneities occur.

These and other aspects of the invention are apparent from and will be elucidated with reference to the embodiments described hereinafter.

In the drawings:

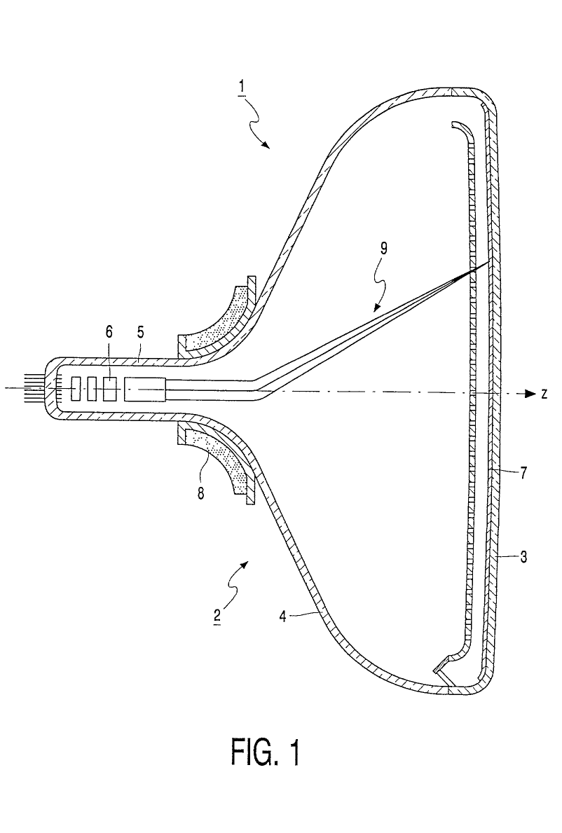

FIG. 1 is a schematic view, partly broken away, of a display device comprising a cathode ray tube,

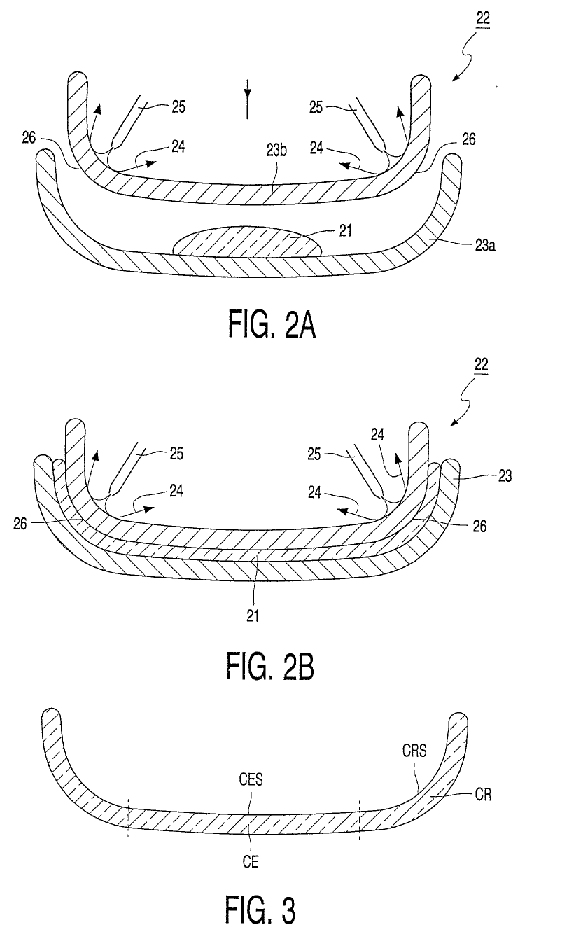

FIG. 2 illustrates the method in accordance with the invention,

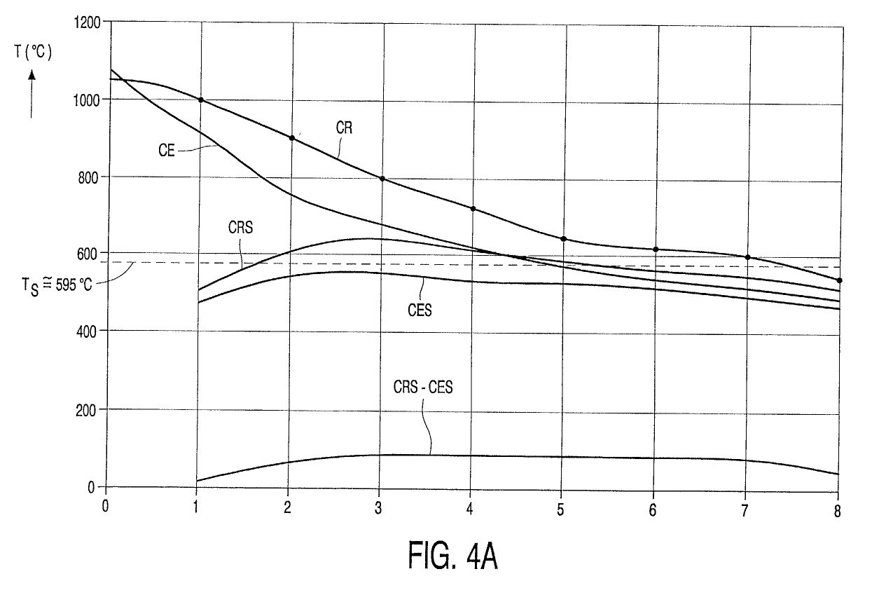

FIG. 3 graphically illustrates the temperature of the glass panel during and after pressing of the method in accordance with the invention, at various positions of the glass panel,

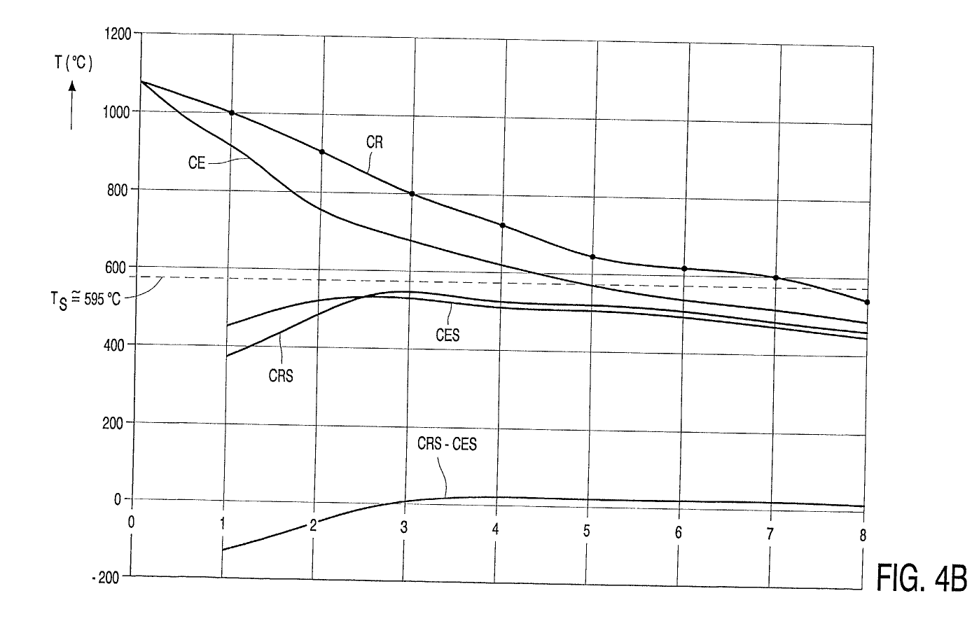

FIGS. 4A and 4B graphically illustrate the stresses inside the glass panel.

The Figures are purely schematic and not drawn to scale. In particular for clarity, some dimensions are strongly exaggerated. In the Figures, like reference numerals refer to like parts, whenever possible.

FIG. 1 is a very schematic view, partly broken away, of a display device comprising a cathode ray tube 1 having a glass envelope 2 which includes a display panel 3, a cone 4 and a neck 5. The neck 5 accommodates an electron gun 6 for generating one or more electron beams 9. The electron beam is focused on a phosphor layer 7 on the inner surface of the display panel 3 and deflected across the display panel 3 in two mutually perpendicular directions by means of a deflection coil system 8.

Display devices often comprise cathode ray tubes or television display tubes 1, which are entirely made of glass and are built up of two or more portions with glass walls of different thicknesses or different heat-absorption characteristics. For example, a glass television display tube 1 customarily comprises a glass display panel 3 and a glass cone 4 which are separately produced and subsequently united by fusing or using a (solder) glass frit, the joint formed being hermetically tight. The display panel 3 of such tubes is formed by a glass wall having a much larger thickness than the wall thickness of the cone parts of such tubes. Such a larger wall thickness of the display panel 3 ensures that it is sufficiently rigid when the eventual tubes comprising such a screen are evacuated.

FIGS. 2A and 2B illustrate the method in accordance with the invention. In a first method step (FIG. 2A), a glass volume 21 at a high temperature (typically 1100° C.-1000° C.) is supplied to a press 22 having moulds whose forms roughly correspond to the form of the glass panel to be made. A glass panel is press-formed in the usual manner by pressing the plunger 23b in the die 23a, with the glass volume 21 in between (FIG. 2A). The hot glass which is in contact with the relatively cold press will decrease the temperature and particularly the surface temperature of the glass. The corners of the plunger are cooled by means of a flow of cold gas or liquid 24. Nozzles 25 are provided to guide the flow to the corners. The plunger may be provided with a tissue (such as a stainless steel tissue 26), preferably at least at the corners 26, to improve the heat transfer of the material of the plunger to the glass. After formation, the glass panel is removed from the press and further cools down.

FIG. 3 illustrates a few points of the glass panel for which the temperature is graphically illustrated in FIGS. 4A and 4B. The point CR is a point at the bulk of the corner inside the glass. The point CRS is the transition point at the corner at the inner surface of the panel. The “inner corner of the panel” denotes this point and an area surrounding this point. The point CE is a point at the bulk of the central part of the glass panel inside the glass, the point CES is a point at the centre at the inner surface of the glass.

FIG. 4A illustrates schematically the temperatures at these points in a conventional method. The temperature in degrees Celsius is plotted on the vertical axis, the time is plotted in arbitrary units on the horizontal axis, and the units are chosen to be such that the temperature drop per unit is more or less the same. Point 1 stands for the temperatures immediately after pressing. As can be seen, the temperatures at the centre drop faster than at the corner. Also visible is a reheating effect at the points CRS and CES, i.e. the temperature increases initially. This reheating effect is much larger at point CRS than at point CES. As a consequence, a temperature difference in surface temperature (CRS-CES) occurs which runs up to approximately 90° C.-100° C. As a consequence, the compressive surface stresses are much more released at the corners than at the centre. This is, amongst others, dependent on the maximum surface temperature during reheating in comparison with the strain point of the glass. In this example, the temperature at the corner rises above the strain point, here the strain point Ts is approximately 595° C. Particularly when this happens, the strength of the panel is reduced.

FIG. 4B illustrates schematically the temperatures at these points in a method in accordance with the invention. Again, the temperature is plotted in degrees Celsius on the vertical axis, while the time is plotted in arbitrary units on the horizontal axis, and the units are chosen to be such, that the temperature drop per unit is more or less the same. Point 1 stands for the temperatures immediately after pressing. At that point the temperature differences are, in fact, increased since the difference between the surface temperature at the corner and the centre is greatly increased. As can be seen, the temperatures at the centre drop faster than at the corner. Also visible is a reheating effect at the points CRS and CES, i.e. the temperature initially increases. This reheating effect is much larger at point CRS than at point CES as in FIG. 4A. However, in the method in accordance with the invention, the corners were at a temperature lower than the temperature at the centre. In this example, the difference Δ was 120° C. As a consequence, except for the first few point (1-2), the difference in temperature CRS-CES is kept at a much lower value (approximately 20° C.-25° C.) resulting in a more homogeneous stress distribution (i.e. a smaller difference in stress between corners and centre) which improves the quality of the panel. Both temperatures CES and CRS stay below the strain point Ts during the reheating process, as is preferred. In embodiments, the corners of the glass panels may be cooled after press-forming, i.e. during the reheating process to keep the temperature below the strain point. Preferably, both temperatures stay at least 30 degrees below the strain point. In this respect, it is important to note that stress release in the glass panels depends in general on the annealing temperature range, which is 550° C.-600° C., dependent on the glass type. The stress release determines the surface stresses in the finished product to a large degree. FIGS. 4A and 4B emphasize the surface temperature in the corners versus the surface temperature in the centre. The illustrated reheating effect may not be limited to the corners but, in embodiments, could occur around the periphery. In embodiments of the invention, the periphery is kept at a lower surface temperature.

Within the concept of the invention in its broadest sense, the mention of “a surface temperature” is not to be unduly and unjustifiably restrictively interpreted as “thus there must be one and only one fixed value for every point in the corner or periphery”. During the press-forming there could and most likely will be a temperature gradient going from a corner to the centre or going around the periphery. Where a temperature difference between centre and corner or periphery is mentioned within the concept of the invention there is a temperature difference between the centre and the transition point of the corner or of the periphery, i.e. the transition point or area where the radius of curvature of the panel is smallest. The “inner periphery” is the transition line at the inner side of the glass panel and an area surrounding this transition point. Preferably also after press-forming, the inner corners or inner periphery are cooled more than the centre. This may be done, for instance, by blowing relatively cold gas in the inner corners of the panel. Such embodiments do not exclude the fact that the centre is not cooled at all.

It will be clear to a person skilled in the art that many variations are possible within the scope of the invention. In summary, the invention can be described as follows.

To increase the strength of the glass panel, for example of a CRT, the surface temperature of the glass panel at the inner surface of the corners is reduced, during press-forming, to a value below the surface temperature at the inner surface at the centre, the difference being preferably 50° C.-150° C. The forced cooling at the corners compensates for the larger reheating effect in the corners than at the centre that occurs after formation. As a consequence of this compensating effect, a more homogeneous distribution of surface stresses is obtained, increasing the strength of the glass panel. Preferably, the surface temperature is below the strain point during press-forming.

1. A method of manufacturing a display tube comprising the step of press-forming a glass display panel in a press having a plunger, characterized in that, during at least a part of the step of press-forming the glass panel, the surface temperature of the inner corners of the panel is kept at a value below the surface temperature of the centre of the glass panel.

2. A method as claimed in claim 1, characterized in that the difference in surface temperature between corner and centre is between 50° C. and 150° C.

3. A method as claimed in claim 1, characterized in that, during at least a part of the step of press-forming the glass panel, the inner periphery of the panel is kept at a surface temperature below the surface temperature of the centre of the glass panel.

4. A method as claimed in claim 1 or 3, characterized in that, after press-forming, the inner corners or inner periphery are cooled more than the centre.

5. A method as claimed in claim 1 or 3, characterized in that the surface temperature of the inner corners and/or inner periphery is below the strain point of the glass during and after press-forming.

6. A method as claimed in claim 5, characterized in that the surface temperature of the inner corners and/or inner periphery is at least 30° C. below the strain point of the glass during and after press-forming.

7. A method as claimed in claim 1, characterized in that, at the corners, the plunger is provided with heat transfer elements to improve the heat transfer of the material of the plunger to the glass.

8. A method as claimed in claim 6, characterized in that the plunger is provided with a stainless tell tissue as a heat transfer element.
